(19) United States
(12) Patent Application Publication
(10) Pub. No.: US 2011/0011044 A1
(43) Pub. Date: Jan. 20, 2011

(54) BAG FILTER COMPRISING FILTER FELT OF META-ARAMID AND PARA-ARAMID STAPLE FIBER

(75) Inventors: ANIL KOHLI, Midlothian, VA (US); Kurt Hans Wyss, Chavannes De Bogis (CH)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/505,797

(22) Filed: Jul. 20, 2009

(51) Int. Cl. B01D 46/02; B01D 39/08

(52) U.S. Cl. 55/381

(57) ABSTRACT

This invention relates to a bag filter having a tubular section, a closed end, and an open end; the tubular section comprising a filter felt consisting essentially of a batt of an intimate blend of fibers needle-punched to a woven scrim, the blend of fibers consisting of 50 to 70 percent by weight meta-aramid staple fiber, and 30 to 50 percent by weight para-aramid staple fiber; said filter felt having a total basis weight of from 10 to 19 ounces per square yard (340 to 580 grams per square meter).

### BACKGROUND OF THE INVENTION

1. Field of the Invention

This invention relates to high-temperature-service bag filters having improved filtration performance.

2. Description of Related Art

Filter felts and bag filters for hot gas filtration containing aramid staple fibers, are disclosed in U.S. Pat. Nos. 4,100,323 and 4,117,578 to Forsten; U.S. Pat. Nos. 7,456,120 and 7,485,592 to Kohli et al. and United States Patent Application Publication 2009/0049816 to Kohli & Wyss. U.S. Pat. No. 5,429,864 to Samuels discloses two 5.4 oz/yd² batts of poly (m-phenylene isophthalamide) batts needled into 4.0 oz/yd² woven scrim can be used to protect the environment from particulate matter from asphalt plants, coal plants, and other industrial concerns. Due to the high potential environmental impact from such plants and the extreme chemical environment the filters must endure, any improvement that has the potential to improve filtration efficiency is desired.

In particular, the trend in the industry is for more portable asphalt manufacturing facilities and associated bag houses that can be operated where paving of roads is needed. These portable bag houses are generally more compact and use smaller bags on the order of about 3.5 meters in length, versus older larger bags of about 6 meters in length. Therefore there is a need for a filter bag that can provide improved performance at lower filter bag weight.

### BRIEF SUMMARY OF THE INVENTION

This invention relates to a bag filter having a tubular section, a closed end, and an open end; the tubular section comprising a filter felt consisting essentially of a batt of an intimate blend of fibers needle-punched to a woven scrim, the blend of fibers consisting of 50 to 70 percent by weight meta-aramid staple fiber, and 30 to 50 percent by weight para-aramid staple fiber; said filter felt having a total basis weight of from 10 to 19 ounces per square yard (340 to 650 grams per square meter).

### BRIEF DESCRIPTION OF THE DRAWINGS

FIG. 1 illustrates one embodiment of a bag filter having a filter felt.

FIG. 2 presents the filtration performance data of Table 1.

### DETAILED DESCRIPTION OF THE INVENTION

In one embodiment, this invention concerns a bag filter having a tubular section comprising a filter felt consisting essentially of a batt of an intimate blend of fibers consisting of 50 to 70 percent by weight meta-aramid staple fiber and 30 to 50 percent by weight para-aramid staple fiber needle-punched to a woven scrim. In one preferred embodiment the intimate blend of fibers consists of 50 to 67 percent by weight meta-aramid staple fiber and 33 to 50 percent by weight para-aramid staple fiber needle-punched to a woven scrim, and in a most preferred embodiment the intimate blend of fibers consists of 55 to 67 percent by weight meta-aramid staple fiber and 33 to 45 percent by weight para-aramid staple fiber needle-punched to a woven scrim. The bag filter comprises a filter felt that has surprising filtration efficiency performance when compared to other blends of meta- and para-aramid staple fiber filter felts.

The batt of fibers can be obtained from conventional nonwoven sheet forming processes such as air-laying or carding, and in some embodiments layers of un-needled fibers are crosslapped using conventional techniques to form thick fiber batts of sufficient basis weight necessary for felts. The fiber batt and scrim are then consolidated into a filter felt via needlepunching using processes such as disclosed in U.S. Pat. Nos. 2,910,763 and 3,684,284, which are examples of methods known in the art that are useful in the manufacture of the nonwoven fabrics and felt. If desired, the fiber batt can be lightly consolidated by needlepunching, followed by final consolidation with the scrim by additional needlepunching.

The batt of staple fibers consists of an intimate blend of 50 to 70 percent by weight meta-aramid staple fiber and 30 to 50 percent by weight para-aramid staple fiber. In preferred embodiments both the meta- and para-aramid staple fibers are crimped, with both having a crimp frequency of 7 to 14 crimps per inch (2.5 to 5.5 crimps per cm). The staple fibers are dispersed in the batt and felt as an intimate blend, meaning that the types of staple fibers are uniformly mixed and distributed in the batt and felt. This forms a uniform mixture in the felt so as to avoid any localized areas having a high concentration of any one type of fiber in any one portion of the felt.

The intimate staple fiber blend can be formed by many methods. For example, in one embodiment, clumps of crimped staple fibers obtained from bales of different types of staple fibers can be opened by a device such as a picker and then blended by any available method, such as air conveying, to form a more uniform mixture. In an alternative embodiment, the staple fibers can be blended to form a mixture prior to fiber opening in the picker. In still another possible embodiment, the staple fibers may be cutter blended, that is, tows of the fiber types can be combined and then cut into staple. The blend of fibers can then be converted into a nonwoven felt. In one embodiment, this involves forming a fibrous web by use of a device such as a card, although other methods, such as air-laying of the fibers can be used. If desired, the fibrous web can then be sent via conveyor to a device such as a crosslapper to create a crosslapped structure by layering individual webs on top of one another in a zig-zig structure. If desired, the heavy basis weight needle-punched batt of staple fibers can be made from two or more lightly consolidated lower basis weight batts. For example, the lower basis weight batts can be lightly tacked or lightly consolidated on a standard needlepunch machine and then two or more of these lower basis weight batts can be then combined and needlepunched to a scrim to produce a filtration felt. If desired, multiple batts can be needlepunched to the scrim, with one or two batts needlepunched to one or both sides of the scrim. Single or multiple passes through the needling station is possible.

The intimate blend of fibers consists of aramid fibers because these fibers are particularly useful in the filtration of high temperature gases, for example at 175° C. or more. Fibers such as polyesters are not useful at high temperatures due to their relatively low glass transition temperatures (about 150° C.), meaning that the mechanical integrity of the fiber and a filter bag will be compromised when the glass transition temperature is exceeded. Even a small quantity of polyester fiber (or other material having a relatively low glass transition temperature) in the filter media of a filter bag can compromise performance at high temperatures. Aramid fibers have glass transition temperatures in excess of 200° C. and therefore are significantly more mechanically stable at higher temperatures than polyesters and can withstand temperature excursions in excess of 200° C., which would damage a polyester-containing bag.

In some embodiments, the woven scrim has a basis weight of about 0.5 to 4 ounces per square yard (17 to 135 grams per square meter), preferably about 1 to 2 ounces per square yard (34 to 70 grams per square meter). In some embodiments the woven scrim comprises a fiber selected from the group consisting of aramid fibers, especially meta-aramid fibers; poly(phenylene sulfide) fibers; poly(sulfone-amide) fibers; fluoropolymer fibers; polyimide fibers; and mixtures thereof. In some preferred embodiments, the woven scrim comprises yarns containing poly(metaphenylene isophthalamide) staple or continuous fibers. In one preferred embodiment the scrim is woven with a plain weave; however, other weaves such as a twill weave are possible.

In some embodiments, the woven scrim is positioned in the interior of the felt with both surfaces of the woven scrim having needled thereto at least one batt of staple fibers. In some other embodiments, the woven scrim is positioned on the outer surface of the felt, with at least one batt needled into one surface. Preferably the woven scrim is a poly(metaphenylene isophthalamide) spun staple yarn scrim that is deployed between two essentially identical batts containing the previously described blend of poly(metaphenylene isophthalamide) and poly(paraphenylene terephthalate) staple fibers that are needled into the scrim. The woven scrim can provide improved bag life by helping to maintain the mechanical integrity of the felt, especially in asphalt applications that use reprocessed asphalt or other applications that operate at a high humidity.

The meta-aramid fiber includes meta-oriented synthetic aromatic polyamides and the para-aramid fiber includes para-oriented synthetic aromatic polyamides. The polymers must be of fiber-forming molecular weight in order to be shaped into fibers. The polymers can include polyamide homopolymers, copolymers, and mixtures thereof which are predominantly aromatic, wherein at least 85% of the amide (—CONH—) linkages are attached directly to two aromatic rings. The rings can be unsubstituted or substituted. The polymers are meta-aramid when the two rings or radicals are meta oriented with respect to each other along the molecular chain; the polymers are para-aramid when the two rings or radicals are para oriented with respect to each other along the molecular chain. Preferably copolymers have no more than 10 percent of other diamines substituted for a primary diamine used in forming the polymer or no more than 10 percent of other diacid chlorides substituted for a primary diacid chloride used in forming the polymer. Additives can be used with the aramid; and it has been found that up to as much as 10 percent by weight of other polymeric material can be blended or bonded with the aramid. The preferred meta-aramid is poly(meta-phenylene isophthalamide) (MPD-I). One such meta-aramid fiber is Nomex® aramid fiber available from E. I. du Pont de Nemours and Company of Wilmington, Del. (DuPont), however, meta-aramid fibers are available in various styles under the trademarks Tejinconex®, available from Teijin Ltd. of Tokyo, Japan; New Star® Meta-aramid, available from Yantai Spandex Co. Ltd, of Shandong Province, China; and Chinfunex® Aramid 1313 available from Guangdong Charming Chemical Co. Ltd., of Xinhui in Guangdong, China. Meta-aramid fibers are inherently flame resistant and can be spun by dry or wet spinning using any number of processes; however, U.S. Pat. Nos. 3,063,966; 3,227,793; 3,287,324; 3,414,645; and 5,667,743 are illustrative of useful methods for making aramid fibers that could be used in this invention.

In a preferred embodiment, the meta-aramid fiber has a degree of crystallinity of at least 20% and more preferably at least 25%. For purposes of illustration due to ease of formation of the final fiber a practical upper limit of crystallinity is 50% (although higher percentages are considered suitable). Generally, the crystallinity will be in a range from 25 to 40%. One example of a commercial meta-aramid fiber having this degree of crystallinity is Nomex® T450 available from DuPont.

The degree of crystallinity of an meta-aramid fiber can be determined by one of two methods. The first method is employed with a non-voided fiber while the second is on a fiber that is not totally free of voids.

The percent crystallinity of meta-aramids in the first method is determined by first generating a linear calibration curve for crystallinity using good, essentially non-voided samples. For such non-voided samples the specific volume (1/density) can be directly related to crystallinity using a two-phase model. The density of the sample is measured in a density gradient column. A meta-aramid film, determined to be non-crystalline by x-ray scattering methods, was measured and found to have an average density of 1.3356 g/cm³. The density of a completely crystalline meta-aramid sample was then determined from the dimensions of the x-ray unit cell to be 1.4699 g/cm³. Once these 0% and 100% crystallinity end points are established, the crystallinity of any non-voided experimental sample for which the density is known can be determined from this linear relationship:

$$Crystallinity = \frac{( 1 / non \text{-} crystalline density ) - ( 1 / experimental density )}{( 1 / non \text{-} crystalline density ) - ( 1 / fully \text{-} crystalline density )}$$

Since many fiber samples are not totally free of voids, Raman spectroscopy is the preferred method to determine crystallinity. Since the Raman measurement is not sensitive to void content, the relative intensity of the carbonyl bond stretch at 1650 cm⁻¹ can be used to determine the crystallinity of a meta-aramid in any form, whether voided or not. To accomplish this, a linear relationship between crystallinity and the intensity of the carbonyl bond stretch at 1650 cm^{31 1}, normalized to the intensity of the ring stretching mode at 1002 cm⁻¹, was developed using minimally voided samples whose crystallinity was previously determined and known from density measurements as described above. The following empirical relationship, which is dependent on the density calibration curve, was developed for percent crystallinity using a Nicolet Model 910 FT-Raman Spectrometer:

$$\% Crystallinity = \frac{100.0 \times ( I ( 1650 {cm}^{- 1} ) - 0.2601 )}{0.1247}$$

where I(1650 cm⁻¹) is the Raman intensity of the meta-aramid sample at that point. Using this intensity the percent crystallinity of the experiment sample is calculated from the equation.

Meta-aramid fibers, when spun from solution, quenched, and dried using temperatures below the glass transition temperature, without additional heat or chemical treatment, develop only minor levels of crystallinity. Such fibers have a percent crystallinity of less than 15 percent when the crystallinity of the fiber is measured using Raman scattering techniques. These fibers with a low degree of crystallinity are considered amorphous meta-aramid fibers that can be crystallized through the use of heat or chemical means. The level of crystallinity can be increased by heat treatment at or above the glass transition temperature of the polymer. Such heat is typically applied by contacting the fiber with heated rolls under tension for a time sufficient to impart the desired amount of crystallinity to the fiber.

The level of crystallinity of m-aramid fibers can be increased by a chemical treatment, and in some embodiments this includes methods that color, dye, or mock dye the fibers prior to being incorporated into a fabric. Some methods are disclosed in, for example, U.S. Pat. Nos. 4,668,234; 4,755,335; 4,883,496; and 5,096,459. A dye assist agent, also known as a dye carrier may be used to help increase dye pick up of the aramid fibers. Useful dye carriers include aryl ether, benzyl alcohol, or acetophenone.

The preferred para-aramid is poly (para-phenylene terephthalamide) (PPD-T). One such para-aramid fiber is Kevlar® aramid fiber available from DuPont, however, para-aramid fibers are also available under the trademark Twaron®, available from Teijin Ltd. of Tokyo, Japan. For the purposes herein, Technora® fiber, which is also available from Teijin Ltd. of Tokyo, Japan, and is made from copoly(p-phenylene/3,4′diphenyl ester terephthalamide), is considered a para-aramid fiber. Methods for making para-aramid fibers are generally disclosed in, for example, U.S. Pat. Nos. 3,869,430; 3,869,429; and 3,767,756.

Construction of a filter felt requires imparting certain mechanical features into the felt that will allow it to withstand the rigors of being fabricated into filter bags and being exposed to hot gases and pressure fluctuations in hot gas bag houses. An important requirement is that the filter felt have a basis weight of from 10 to 19 ounces per square yard (340 to 650 grams per square meter). Filter felts of less than 10 oz/yd² (340 g/m²) tend to not have adequate stability to mechanical working and can fail prematurely when used as bag filter material in hot gas filtration bag houses. The pressure drop across the filter felt increases with basis weight, therefore filter felt basis weights greater than 19 oz/yd² (650 g/m²) are generally not desired.

In some embodiments, the filter felt is needled such that it has about 2675 to 4450 total penetrations per square inch (414 to 690 total penetrations per square centimeter). In a practical embodiment, these penetrations are divided about equally on both sides of the needle-punched batt. That is, for 2675 total penetrations/in² (414 penetrations/cm²), the batt is consolidated such that about 1337 needle penetrations/in² (about 207 penetrations/cm²) are applied to the batt from one side or face of the batt with an essentially equal number applied to the other side or face of the batt. Likewise, for 4450 total penetrations/in² (690 penetrations/cm²), 2225 needle penetrations/in² (345 penetrations/cm²) are applied to the batt from one face with an essentially equal number applied to the other face. It is believed that for those embodiments where improved durability of the filter felt is desired, at least about 2675 total penetrations/in² (414 penetrations/cm²) are needed. Consolidation in excess of about 4450 total penetrations/in² (690 penetrations/cm²) is considered undesirable because of the excess compaction of the felt that could potentially cause higher pressure drops across the felt. As used herein, the number of total penetrations is the additive number of needle penetrations from both sides used to pre-consolidate the layers of the filter felt plus any subsequent needle penetrations from both sides used to finally consolidate the layers of the filter felt. In other words, the number of total penetrations is the sum of all needle penetrations into the filter felt from all needle punch passes.

In some embodiments, the filter felt has a leakage in milligrams per dry standard cubic meter of air per VDI 3926 of from 0.02 to 0.35 mg/m³; in some embodiments the filter felt has a leakage per VDI 3926 of from 0.5 to 0.3 mg/m³. This is an exceeding low amount of leakage for a filter felt and in general is significantly less than the amount seen with a filter felt of equivalent basis weight made with a batt that contains other blends of aramid fibers. VDI is Verein Deutscher Ingenieure (The Association of German Engineers).

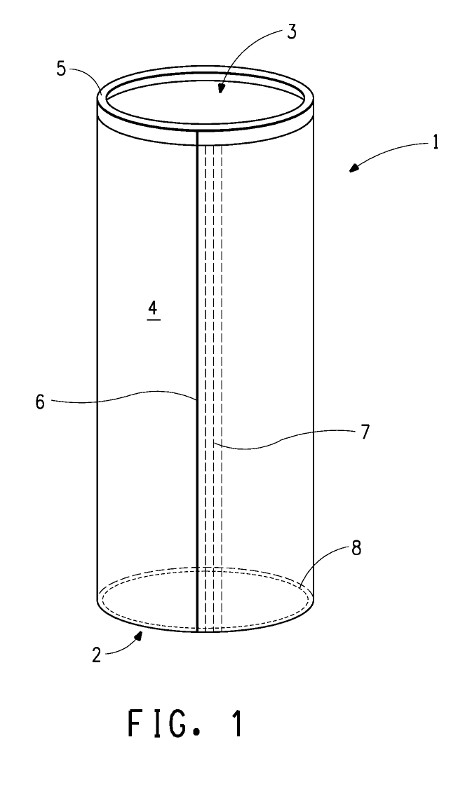

FIG. 1 illustrates one embodiment of the filter bag comprising the filter felt. Filter bag 1 has a closed end 2, an open end 3, and a tubular section 4. In the embodiment represented, the filter bag also has a snap ring 5 attached to the open end of the bag. The snap ring can be made of spring steel or any other suitable material. The tubular section 4 of this bag is comprised of a filtration felt that is overlapped, forming a seam 6 sewn with stitching 7. The closed end of the bag in this embodiment is also comprised of a filtration felt that is stitched at 8 to the end of the felt used for the tubular section. While FIG. 1 represents a preferred embodiment, other potential constructions, orientations, and features of bag filters may be used, such as those disclosed in U.S. Pat. No. 3,524,304 to Wittemeier et al.; U.S. Pat. No. 4,056,374 to Hixenbaugh; U.S. Pat. No. 4,310,336 to Peterson; U.S. Pat. No. 4,481,022 to Reier; U.S. Pat. No. 4,490,253 to Tafara; and/or U.S. Pat. No. 4,585,833 to Tafara.

In some embodiments, the closed end 2 of the filter bag, as shown in FIG. 1, is a disk of filter felt sewn to the tubular section. In some other embodiments the closed end can be made of some other material, for example in some situations a metallic closed end might be needed. In other embodiments the closed end can be ultrasonically, adhesively, or heat seamed or sealed in some other manner than sewing. In another embodiment the felt used in the tubular section of the bag can be gathered together or folded, and then sealed, to form the closed end. In some embodiments the open end 3 of the bag may be provided with hardware to attach the bag to the cell plate. In some other embodiments the open end of the bag may be sized such that a snug fit is accomplished by sliding the bag over a specially designed cell plate.

As used herein, the term “filter bag” is meant to include not only the generic type of filter bag disclosed in the figure, but many other different embodiments of bag filters or tubular filters, including filter pockets or envelope bags. The tubular section of the bag is not meant to be limited to only round or cylindrical tubes but also includes such things, for example, as flat tubes, which could be used for filter pockets and envelope bags,

### Test Methods

Filtration efficiency was measured using procedure VDI 3926 “Standard Test for the Evaluation of Cleanable Filter Media” that employs aluminum oxide dust. This is a standard test performed in Europe to determine the filtration efficiency of felts. Lower amounts of leakage correspond to higher filtration efficiencies.

### Example 1

Intimate staple fiber blends containing 2 denier per filament (2.2 dtex per filament) meta-aramid fiber, specifically poly(meta-phenylene isophthalamide) fiber, having a 3-inch (76 mm) cut length (available under the trademark Nomex® fiber from DuPont and 1.5 denier per filament (1.7 dtex per filament) para-aramid fiber, specifically poly(para-phenylene terephthalamide) fiber, also having a 3-inch (76 mm) cut length (also available under the trademark Kevlar® fiber from DuPont) were made by combining and mixing the staple fibers from bales. The blends had meta/para fiber blend weight ratios of 55/45 and 67/33 of poly(meta-phenylene isophthalamide) fiber and poly(para-phenylene terephthalamide) fiber, respectively. A blend of 75/25 poly(meta-phenylene isophthalamide) fiber and poly(para-phenylene terephthalamide) fiber was used as a control.

Using standard carding and cross lapping equipment these staple fibers were converted into crosslapped batts. A 1.5 oz/yd² plain-weave woven scrim made from spun staple poly(meta-phenylene isophthalamide) fiber yarns was then inserted between two of the batts. The three-layer structure was then pre-consolidated by needlepunching 450 penetrations/in² on each side. The structure was further consolidated by further needlepunching on both sides. The total number of penetrations for each item, including the 900 pre-consolidation penetrations, is shown in the Table.

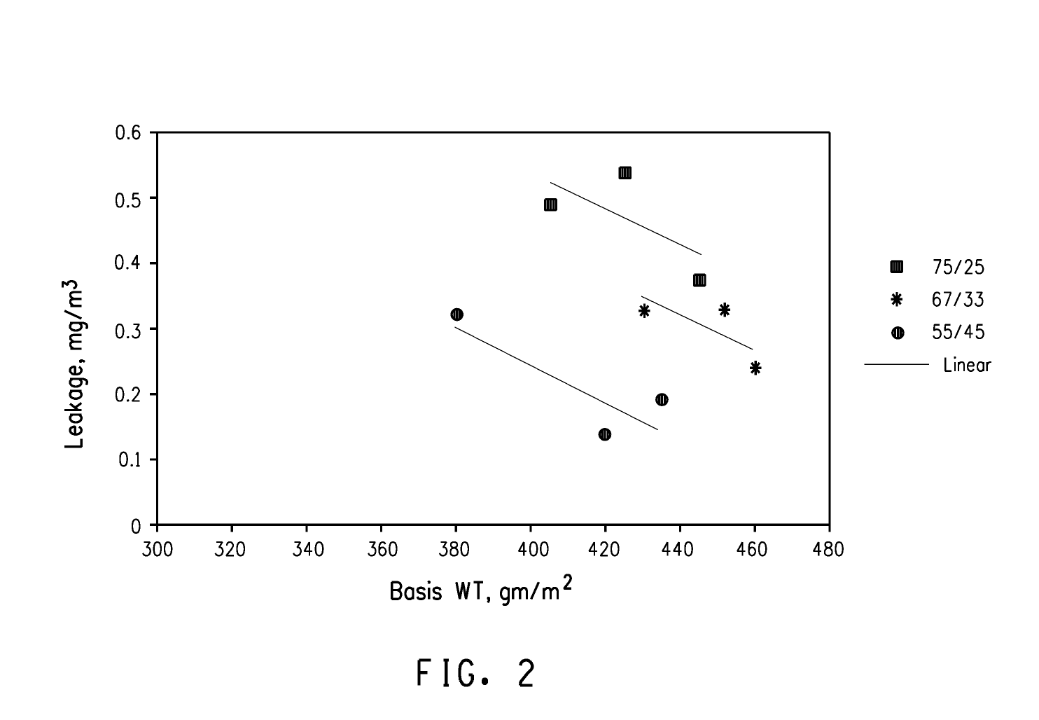

All of he felts were then evaluated for filtration efficiency using the procedure VDI 3926 and the results are shown in the Table. FIG. 2 is an illustration of the linear fit of the data of the Table. The 55/45 and 67/33 blended filter felts had significantly lower leakage than the 75/25 aramid felts at a comparable basis weight. Bag filters made from these felts will result in a very efficient operation of the bag house. Also, this offers potential for using lower basis weight bags resulting in lower operating cost. Filter bags made from these blended aramid fiber felts will pass the current EPA emission limits for an asphalt plant and have the potential for meeting higher emission standards in the future and be able to withstand very high temperature variations, such as extended filtering of hot gases at temperatures in excess of 175 C.

TABLE

| | | Total | Basis | |
|---|---|---|---|---|
| | Blend Ratio | Penetrations/ | Weight | Leakage |
| Item | Meta-/Para-Aramid | in² | g/m² | mg/m³ |
| A | 75/25 | 2675 | 425 | 0.54 |
| B | 72/25 | 3563 | 445 | 0.38 |
| C | 75/25 | 4450 | 405 | 0.49 |
| 1-1 | 67/33 | 2675 | 460 | 0.24 |
| 1-2 | 67/33 | 3563 | 430 | 0.32 |
| 1-3 | 67/33 | 4450 | 450 | 0.32 |
| 1-4 | 55/45 | 2675 | 420 | 0.14 |
| 1-5 | 55/45 | 3563 | 435 | 0.19 |
| 1-6 | 55/45 | 4450 | 380 | 0.32 |

Any of the filter felts made in Example 1 can be made into a bag filter. The bag filter can have a closed end, an open end, and a tubular section. The filter felt can be fashioned into a cylinder with the edges overlapping. The edges can then be attached by stitching them to form a seam 6 as shown in FIG. 1, which forms the tubular section of the filter bag. Additional filter felt can be attached to the end of the tubular section by stitching to form the closed end of the bag. If desired, a spring steel metal snap ring can be attached to the open end of the bag.

What is claimed is:

1. A bag filter having a tubular section, a closed end, and an open end; the tubular section comprising a filter felt consisting essentially of a batt of an intimate blend of fibers needle-punched to a woven scrim, the blend of fibers consisting of
a) 50 to 70 percent by weight meta-aramid staple fiber, and
b) 30 to 50 percent by weight para-aramid staple fiber;
said filter felt having a total basis weight of from 10 to 19 ounces per square yard (340 to 650 grams per square meter).

2. The bag filter of claim 1, wherein the blend of fibers consists of
a) 50 to 67 percent by weight meta-aramid staple fiber, and
b) 33 to 50 percent by weight para-aramid staple fiber.

3. The bag filter of claim 2, wherein the blend of fibers consists of
a) 55 to 67 percent by weight meta-aramid staple fiber, and
b) 33 to 45 percent by weight para-aramid staple fiber.

4. The bag filter of claim 1, wherein filtration efficiency per VDI 3926 as measured by the leakage of particles through the felt is 0.02 to 0.35 milligrams per dry standard cubic meter of air.

5. The bag filter of claim 1, wherein filtration efficiency per VDI 3926 as measured by the total mass of the mean outlet particle concentration through the felt of 0.5 to 0.3 milligrams per dry standard cubic meter of air.

6. The bag filter of claim 1, having 2675 to 4450 total penetrations per square inch (414 to 690 total penetrations per square centimeter).

7. The bag filter of claim 1, wherein the woven scrim comprises a fiber from the group consisting of aramid fibers, poly(phenylene sulfide) fibers, poly(sulfone-amide) fibers, fluoropolymer fibers, polyimide fibers, and mixtures thereof.

8. The bag filter of claim 7, wherein the aramid fibers are poly(metaphenylene isophthalamide fibers).
